(19) United States
(12) Patent Application Publication
(10) Pub. No.: US 2026/0212016 A1
(43) Pub. Date: Jul. 23, 2026

(54) AUTOMOTIVE SAFETY INTEGRITY LEVEL CLASSIFICATIONS FOR SYSTEMS HOSTED BY LOWER-INTEGRITY HARDWARE

(71) Applicant: GM Global Technology Operations LLC, Detroit, MI (US)

(72) Inventors: Gurmitsingh Mohindersingh Banvait, Novi, MI (US); Venkateswara Raju Mudunuri, Lake Orion, MI (US)

(73) Assignee: GM Global Technology Operations LLC, Detroit, MI (US)

(21) Appl. No.: 19/032,346

(22) Filed: Jan. 20, 2025

(51) Int. Cl. G06F 21/57; B60W 30/08; G06F 11/07

(52) U.S. Cl. CPC G06F 21/57; B60W 30/08; G06F 11/0793

(57) ABSTRACT

A system including first data processing hardware having a first safety integrity level (SIL) classification, and first memory hardware in communication with the first data processing hardware and storing instructions that, when executed by the first data processing hardware, cause the first data processing hardware to perform operations. The operations include executing a monitoring module for monitoring execution of a software module, the software module executing on second data processing hardware having a second SIL classification lower than the first SIL classification, detecting a fault condition associated with the software module or the second data processing hardware and, based on detecting the fault condition, performing a remedial action for the software module or the second data processing hardware to increase an SIL classification of the software module.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Some systems include a higher-integrity hardware module and a lower-integrity hardware module. In such systems, a software module may be assigned to either the higher-integrity hardware module or the lower-integrity hardware module based on requirements of the software module.

The present disclosure relates generally to improving automotive safety integrity level (ASIL) classification for systems hosted by lower-integrity hardware.

### SUMMARY

One aspect of the disclosure provides a vehicle including a control module. The control module includes a first hardware module having a first automotive safety integrity level (ASIL) classification. The first hardware module includes first data processing hardware, and first memory hardware in communication with the first data processing hardware and storing instructions that, when executed by the first data processing hardware, cause the first data processing hardware to execute a software module of the control module. The control module also includes a second hardware module having a second ASIL classification higher than the first ASIL classification. The second hardware module includes second data processing hardware, and second memory hardware in communication with the second data processing hardware and storing instructions that, when executed by the second data processing hardware, cause the second data processing hardware to perform second operations including executing a monitoring module for monitoring the execution of the software module to increase an ASIL classification of the software module.

Implementations of the disclosure may include one or more of the following optional features. In some implementations, the second operations also include detecting a fault condition associated with the software module or the first hardware module, and based on detecting the fault condition, performing a remedial action. In some examples, the vehicle also includes an advanced driver assistance system (ADAS) that includes the control module. In some implementations, the software module includes at least one of a fusion system for the ADAS, a planning system for the ADAS, a localization system for the ADAS, or a control system for the ADAS.

In some examples, the monitoring module monitors the execution of the software module by monitoring for a safety-critical software fault. Monitoring for the safety-critical software fault may include monitoring for at least one of a boundary condition fault, an input value fault, or an output value fault. In some implementations, the monitoring module monitors the execution of the software module by monitoring for hardware faults of the first hardware module.

Another aspect of the disclosure provides a computer-implemented method executed on first data processing hardware having a first safety integrity level (SIL) classification, wherein execution of the computer-implemented method by the first data processing hardware causes the first data processing hardware to perform operations. The operations include executing a monitoring module for monitoring execution of a software module, the software module executing on second data processing hardware having a second SIL classification lower than the first SIL classification, detecting a fault condition associated with the software module or the second data processing hardware, and, based on detecting the fault condition, performing a remedial action for the software module or the second data processing hardware to increase an SIL classification of the software module.

Implementations of the disclosure may include one or more of the following optional features. In some examples, the second data processing hardware executes an advanced driver assistance system (ADAS) that includes the software module. In some implementations, the software module includes at least one of a fusion system for an advanced driver assistance system (ADAS), a planning system for the ADAS, a localization system for the ADAS, or a control system for the ADAS. The monitoring module may monitor the execution of the software module by monitoring for a safety-critical software fault. Monitoring for the safety-critical software fault may include monitoring for at least one of a boundary condition fault, an input value fault, or an output value fault.

In some examples, the monitoring module monitors the execution of the software module by monitoring for hardware faults of the second data processing hardware. In some implementations, the computer-implemented method is executed by an advanced driver assistance system (ADAS) that includes the first data processing hardware and the second data processing hardware.

Yet another aspect of the disclosure provides a system includes first data processing hardware having a first safety integrity level (SIL) classification, and first memory hardware in communication with the first data processing hardware and storing instructions that, when executed by the first data processing hardware, cause the first data processing hardware to perform operations. The operations include executing a monitoring module for monitoring execution of a software module, the software module executing on second data processing hardware having a second SIL classification lower than the first SIL classification, detecting a fault condition associated with the software module or the second data processing hardware, and, based on detecting the fault condition, performing a remedial action for the software module or the second data processing hardware to increase an SIL classification of the software module.

Implementations of the disclosure may include one or more of the following optional features. In some implementations, the software module includes at least one of a fusion system for an advanced driver assistance system (ADAS), a planning system for the ADAS, a localization system for the ADAS, or a control system for the ADAS. In some examples, the monitoring module monitors the execution of the software module by monitoring for a safety-critical software fault. Monitoring for the safety-critical software fault may include monitoring for at least one of a boundary condition fault, an input value fault, or an output value fault.

In some examples, the monitoring module monitors the execution of the software module by monitoring for hardware faults of the second data processing hardware. In some implementations, the system includes an advanced driver assistance system (ADAS) that includes the first data processing hardware and the second data processing hardware.

### BRIEF DESCRIPTION OF THE DRAWINGS

The drawings described herein are for illustrative purposes only of selected configurations and are not intended to limit the scope of the present disclosure.

FIG. 1 is a view of an example vehicle including an advanced driver assistance system (ADAS) in accordance with the principles of the present disclosure.

FIG. 2 is a schematic view of the ADAS of FIG. 1.

FIG. 3 is a schematic view of software modules of the ADAS of FIG. 1.

FIG. 4 is a flowchart of an example arrangement of operations of a method for improving the automotive safety integrity level (ASIL) classification of the ADAS of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Safety critical automated driving (SCAD) (e.g., Society of Automotive Engineers (SAE) levels L2 and L3) relies on control systems having large amounts of computing resources to execute sophisticated artificial intelligence (AI) and/or machine learning (ML) algorithms. SCAD features may lead to mishaps or accidents when control system systematic un-detected hardware or software failures occur. SCAD features are preferably deployed on hardware with sufficiently high integrity (e.g., a sufficiently high safety integrity level (SIL) classification, such as an automotive safety integrity level (ASIL) classification) such that hardware failures may be detected, and mishaps can be remediated by the system. However, current hardware with a sufficient integrity may not be capable of executing the sophisticated AI and ML algorithms of current and future SCAD systems, and hardware with sufficient amounts of computing resources are available but may not have sufficient integrity to safely deploy the sophisticated AI and ML algorithms. Thus, currently, these sophisticated AI and ML algorithms can be deployed, but resulting SCAD-enabled vehicles may be prone to mishaps or accidents due to un-detected hardware failures because of the hardware's lower-integrity. For safety, SCAD features should be allocated to higher-integrity devices or hardware that includes low level diagnostics for directly detecting failures. With lower-integrity hardware, some failures may remain undiagnosed and overall diagnostic coverage may be low or medium. Therefore, there is a need for methods and systems for improving the integrity (e.g., ASIL classification) for systems hosted by lower-integrity hardware. In disclosed configurations, to provide high diagnostic coverage (as required per an allocated safety goal), disclosed methods and systems assess failures in the context of an application (e.g., software modules or algorithms) and detect safety critical faults using application-level software algorithm/monitor modules running on a higher-integrity device. Here, the functions or algorithms of an application running on low-integrity devices may be split piecewise and be monitored independently by monitoring modules executing on higher-integrity hardware. Disclosed configurations enable a manufacturer to, for example, deploy advanced L2 and L3 SAE SCAD features as a software solution on existing lower-integrity hardware, thus, obviating a necessity for higher-integrity, higher-compute-resources hardware.

While configurations are shown and described herein in connection with improving an ASIL classification of an advanced driver assistance system (ADAS) of a vehicle, it should be understood that disclosed configurations may, additionally, or alternatively, be used for improving a SIL classification (e.g., an ASIL classification) of any other system of a vehicle. Moreover, it should be understood that disclosed configurations may, additionally, or alternatively, be used for improving an SIL classification for any other type of device (e.g., a video conference system, a computer, a bicycle, industrial equipment, etc.). Here, a vehicle or device may be operated by a person or may operate independently.

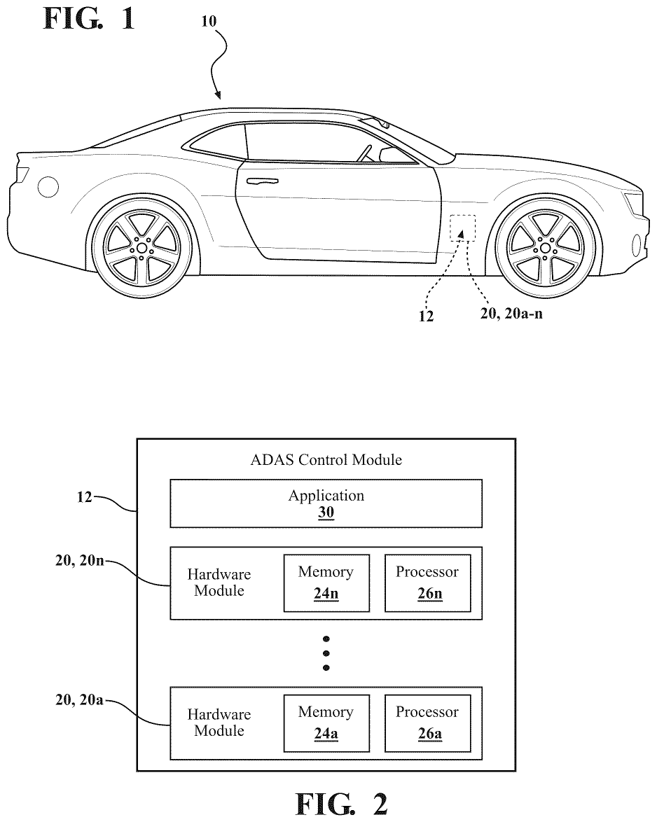

With particular reference to FIGS. 1, 2, and 3, a vehicle 10 (e.g., an automobile, a truck, an airplane, a train, a motorcycle, etc.) is shown in conjunction with an advanced driver assistance system (ADAS) 12 configured to improve the integrity (e.g., an ASIL classification) of an application 30 of the ADAS 12 that is hosted by lower-integrity hardware of the ADAS 12. The ADAS 12 may be implemented by a controller having a plurality of hardware modules 20, 20a-n for executing various functions of the ADAS 12, a plurality of sensors, and a plurality of control outputs. Each of the hardware modules 20 includes corresponding memory hardware 24, 24a-n, and corresponding data processing hardware (e.g., a processor) 26, 26a-n. Here, the memory hardware 24 of a particular hardware module 20 stores machine-readable instructions that may be executed by the data processing hardware 26 of the particular hardware module 20 to perform the operations shown in FIG. 4, or operations, applications, monitoring modules, algorithms, or software functions described elsewhere in the present disclosure.

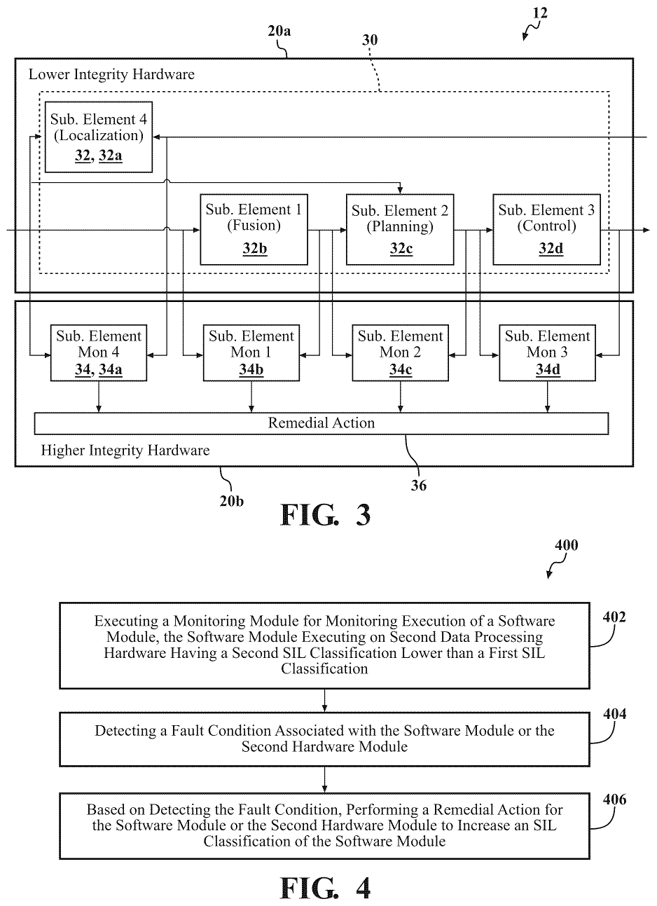

As shown in FIG. 3, at least one of the hardware modules 20 (e.g., hardware module 20a) of the ADAS 12 has a lower integrity (e.g., a lower ASIL classification) than another hardware module 20 (e.g., hardware module 20b). Here, to provide higher diagnostic coverage (e.g., as required per an allocated safety goal), the application 30 (e.g., of a SCAD system 30) executing on the lower-integrity hardware module 20a is split piecewise into a plurality of algorithms or software modules 32, 32a-n (e.g., SCAD sub-systems) that are executed on the lower-integrity hardware module 20a. In some implementations, the SCAD system 30 is split using ASIL decomposition (e.g., per a functional safety process or per ISO 26262). Example software modules 32 for the SCAD system 30 include, but are not limited to, a fusion system 32a, a planning system 32b, a localization system 32c, and a control system 32d. Here, the fusion system 32a fuses objects detected by different ADAS sensors of the ADAS 12 to create one or more scenes including the detected objects; the planning system 32b plans a driving path for the vehicle 10 based on the detected objects, the created scene(s), and one or more constraints; the localization system 32c determines a position of the vehicle 10; and the control system 32d converts the planned path into actuation commands that are performed to operate the vehicle 10 along the driving path.

If the lower-integrity hardware module 20a fails and the failure is undetected, SCAD sub-system outputs (i.e., outputs of the software modules 32) may be erroneous. Accordingly, monitoring modules 34, 34a-n executing on the higher-integrity hardware module 20b continuously monitor a corresponding software module 32. In some examples, the monitoring modules 34 monitor the inputs and outputs (e.g., critical outputs) of their corresponding software module 32 for, for example, certain pre-defined checks (e.g., using pre-defined thresholds), a boundary condition fault, an input value fault, a safety-critical software fault, or an output value fault. Here a fault may be due to a hardware fault of the lower-integrity hardware 20a or a software fault of the corresponding software modules 32. In some examples, developers of the software modules 32 define expected outputs and/or expected ranges of outputs that are used by the monitoring modules 34 to detect faults. In some implementations, developers of the software modules 32 provide an application programming interface (API) for monitoring inputs, outputs, or variables of the software modules 32 that are stored in, for example, global memory of the software modules 32. In some examples, data of the software modules 32 is automatically logged (e.g., by a data logger) into memory of the higher-integrity hardware 20b for access by the monitoring modules 20b.

The monitoring module 34a may monitor the fusion system 32a by selecting nearest objects around the vehicle 10 and verifying that a fused object list includes the nearest objects. If objects are missing, the monitoring module 34a may repeat the check during a next update and trigger a remedial action if a discrepancy persists. The monitoring module 34b may monitor the planning system 32b by checking the planned path against an object list, constraints and, in some examples, using a simplified AI model that is trained to detect discrepancies in a planned path. The monitoring module 34c may monitor the localization system 32c using a vehicle model to rationalize movement of the vehicle 10 with detected discrepancies. The monitoring module 34d may monitor the control system 32d by verifying that actuation commands are consistent with a planned path and detect discrepancies, and limiting actuation commands to prevent safety goal violations. In some implementations, the monitoring modules 34 are designed based on: a list of potential undiagnosed failure modes obtained by analyzing the lower-integrity hardware 20a; classified failure modes of safe vs. unsafe operation based on the hosted application 30 (i.e., of the ADAS 12); and a verification that intended SW algorithms/monitors can detect and remediate the failures within required a particular fault tolerance time interval (FTTI).

FIG. 4 is a flowchart of an example arrangement of operations of a method 400 for improving the ASIL classification of the ADAS 12 of FIG. 1. The operations may be performed by data processing hardware (e.g., the processor 26) based on executing instructions stored on memory (e.g., the memory hardware 24). Many other ways of implementing the method 400 may be employed. For example, the order of execution of the operations may be changed, and/or one or more of the operations and/or interactions may be changed, eliminated, sub-divided, or combined. Additionally, the operations of FIG. 3 may be carried out sequentially and/or in parallel by, for example, separate processing threads, processors, devices, discrete logic, circuits, etc. The method 400 is executed on first data processing hardware 26 of a first hardware module 20b having a first SIL classification (e.g., a first ASIL classification), wherein execution of the computer-implemented method 400 by the first data processing hardware 26 causes the first data processing hardware 26 to perform the operations of the method 400.

At operation 402, the method 400 includes executing a monitoring module 34 on the first hardware module 20b for monitoring execution of a software module 32. Here, the software module 32 is executing on second data processing hardware 26 of a second hardware module 20a having a second SIL classification (e.g., a second ASIL classification) lower than the first SIL classification. At operation 404, the method 400 includes detecting a fault condition associated with the software module 32 or the second hardware module 20a. At operation 406, the method 400 includes, based on detecting the fault condition, performing a remedial action for the software module 32 or the second hardware module 20a to increase the SIL classification of the software module 32.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising a control module, the control module comprising:
a first hardware module having a first automotive safety integrity level (ASIL) classification, the first hardware module comprising:
first data processing hardware; and
first memory hardware in communication with the first data processing hardware and storing instructions that, when executed by the first data processing hardware, cause the first data processing hardware to execute a software module of the control module; and
a second hardware module having a second ASIL classification higher than the first ASIL classification, the second hardware module comprising:
second data processing hardware; and
second memory hardware in communication with the second data processing hardware and storing instructions that, when executed by the second data processing hardware, cause the second data processing hardware to perform second operations comprising executing a monitoring module for monitoring the execution of the software module to increase an ASIL classification of the software module.

2. The vehicle of claim 1, wherein the second operations further comprise:
detecting a fault condition associated with the software module or the first hardware module; and
based on detecting the fault condition, performing a remedial action.

3. The vehicle of claim 1, wherein the vehicle further comprises an advanced driver assistance system (ADAS) comprising the control module.

4. The vehicle of claim 3, wherein the software module comprises at least one of a fusion system for the ADAS, a planning system for the ADAS, a localization system for the ADAS, or a control system for the ADAS.

5. The vehicle of claim 1, wherein the monitoring module monitors the execution of the software module by monitoring for a safety-critical software fault.

6. The vehicle of claim 5, wherein monitoring for the safety-critical software fault comprises monitoring for at least one of a boundary condition fault, an input value fault, or an output value fault.

7. The vehicle of claim 1, wherein the monitoring module monitors the execution of the software module by monitoring for hardware faults of the first hardware module.

8. A computer-implemented method executed on first data processing hardware having a first safety integrity level (SIL) classification, wherein execution of the computer-implemented method by the first data processing hardware causes the first data processing hardware to perform operations comprising:
executing a monitoring module for monitoring execution of a software module, the software module executing on second data processing hardware having a second SIL classification lower than the first SIL classification;
detecting a fault condition associated with the software module or the second data processing hardware; and
based on detecting the fault condition, performing a remedial action for the software module or the second data processing hardware to increase an SIL classification of the software module.

9. The computer-implemented method of claim 8, wherein the second data processing hardware executes an advanced driver assistance system (ADAS) comprising the software module.

10. The computer-implemented method of claim 8, wherein the software module comprises at least one of a fusion system for an advanced driver assistance system (ADAS), a planning system for the ADAS, a localization system for the ADAS, or a control system for the ADAS.

11. The computer-implemented method of claim 8, wherein the monitoring module monitors the execution of the software module by monitoring for a safety-critical software fault.

12. The computer-implemented method of claim 11, wherein monitoring for the safety-critical software fault comprises monitoring for at least one of a boundary condition fault, an input value fault, or an output value fault.

13. The computer-implemented method of claim 8, wherein the monitoring module monitors the execution of the software module by monitoring for hardware faults of the second data processing hardware.

14. The computer-implemented method of claim 8, wherein the computer-implemented method is executed by an advanced driver assistance system (ADAS), the ADAS comprising the first data processing hardware and the second data processing hardware.

15. A system comprising:
first data processing hardware having a first safety integrity level (SIL) classification; and
first memory hardware in communication with the first data processing hardware and storing instructions that, when executed by the first data processing hardware, cause the first data processing hardware to perform operations comprising:
executing a monitoring module for monitoring execution of a software module, the software module executing on second data processing hardware having a second SIL classification lower than the first SIL classification;
detecting a fault condition associated with the software module or the second data processing hardware; and
based on detecting the fault condition, performing a remedial action for the software module or the second data processing hardware to increase an SIL classification of the software module.

16. The system of claim 15, wherein the software module comprises at least one of a fusion system for an advanced driver assistance system (ADAS), a planning system for the ADAS, a localization system for the ADAS, or a control system for the ADAS.

17. The system of claim 15, wherein the monitoring module monitors the execution of the software module by monitoring for a safety-critical software fault.

18. The system of claim 17, wherein monitoring for the safety-critical software fault comprises monitoring for at least one of a boundary condition fault, an input value fault, or an output value fault.

19. The system of claim 18, wherein the monitoring module monitors the execution of the software module by monitoring for hardware faults of the second data processing hardware.

20. The system of claim 15, wherein the system comprises an advanced driver assistance system (ADAS), the ADAS comprising the first data processing hardware and the second data processing hardware.
